(19) United States
(12) Patent Application Publication
(10) Pub. No.: US 2025/0273873 A1
(43) Pub. Date: Aug. 28, 2025

(54) ANTENNA MODULE, VEHICLE, AND BASE STATION

(71) Applicant: Beijing Xiaomi Mobile Software Co., Ltd., Beijing (CN)

(72) Inventors: Zhe ZHANG, Beijing (CN); Wei WANG, Beijing (CN); Kunpeng WEI, Beijing (CN)

(21) Appl. No.: 18/883,678

(22) Filed: Sep. 12, 2024

(30) Foreign Application Priority Data
Feb. 27, 2024 (CN) 202410218589.6

(51) Int. Cl. H01Q 21/24; H01Q 1/24; H01Q 1/27; H01Q 13/10

(52) U.S. Cl. CPC H01Q 21/24; H01Q 1/246; H01Q 1/27; H01Q 13/10

(57) ABSTRACT

An antenna module includes a metal plate, a metal body and an excitation source. The metal body is provided on the metal plate, and includes a first slot and a second slot arranged crosswise and at a set angle. Each of the first slot and the second slot includes a transverse opening penetrating through the metal body along a thickness direction of the metal plate and a longitudinal opening penetrating through the metal body along a plane direction of the metal plate, and a length of the transverse opening and a length of the longitudinal opening are in a set ratio. The excitation source is configured to excite the first slot and the second slot to radiate a circularly polarized wave.

### CROSS-REFERENCE TO RELATED APPLICATIONS

The present application claims the benefit of priority to Chinese Application No. 202410218589.6, filed on Feb. 27, 2024, the content of which is incorporated herein by reference in its entirety.

### FIELD

The present disclosure relates to the technical field of antennas, in particular to an antenna module, a vehicle, and a base station.

### BACKGROUND

With the rapid development of communication technology, there are more and more types of antennas.

### SUMMARY

A first aspect of the present disclosure provides an antenna module, including a metal plate, a metal body, and an excitation source. The metal body is provided on the metal plate, and includes a first slot and a second slot arranged crosswise and at a set angle. Each of the first slot and the second slot includes a transverse opening penetrating through the metal body along a thickness direction of the metal plate and a longitudinal opening penetrating through the metal body along a plane direction of the metal plate. A length of the transverse opening and a length of the longitudinal opening are in a set ratio. The excitation source has an excitation end provided in the first slot and the second slot, and the excitation source is configured to excite the first slot and the second slot to radiate a circularly polarized wave.

A second aspect of the present disclosure provides a vehicle which includes the antenna module according to the first aspect.

A third aspect of the present disclosure provides a base station which includes the antenna module according to the first aspect.

### BRIEF DESCRIPTION OF THE DRAWINGS

The above-mentioned and/or additional aspects and advantages of the present disclosure will be apparent and easily understood from the following description of embodiments taken in conjunction with the accompanying drawings, in which:

FIG. 1 is a schematic perspective view of an antenna module according to an embodiment of the present disclosure;

FIG. 2 is a schematic top view of an antenna module according to an embodiment of the present disclosure;

FIG. 3 is a schematic perspective view of an excitation source in an antenna module according to an embodiment of the present disclosure;

FIG. 4 is a schematic front view of an antenna module according to an embodiment of the present disclosure;

FIG. 5 is a schematic left view of an antenna module according to an embodiment of the present disclosure;

FIG. 6 is an electric field intensity diagram (OT) of antenna module simulation according to an embodiment of the present disclosure;

FIG. 7 is an electric field intensity diagram (0.25 T) of antenna module simulation according to an embodiment of the present disclosure;

FIG. 8 is a graph of port reflection coefficient of antenna module simulation according to an embodiment of the present disclosure;

FIG. 9 is a radiation pattern of antenna module simulation according to an embodiment of the present disclosure;

FIG. 10 is a graph of port reflection coefficient of antenna module simulation according to an embodiment of the present disclosure;

FIG. 11 is a radiation pattern of antenna module simulation according to an embodiment of the present disclosure; and

FIG. 12 is a radiation pattern of antenna module simulation according to an embodiment of the present disclosure.

### DETAILED DESCRIPTION

Hereinafter, embodiments of the present disclosure will be described in detail, examples of which are illustrated in the accompanying drawings, wherein the same or similar reference numerals indicate the same or similar elements or elements having the same or similar functions throughout. The embodiments described below by referring to the drawings are illustrative, only for explaining the present disclosure, and may not be understood as limiting the present disclosure. On the contrary, the embodiments of the present disclosure include all changes, modifications and equivalents that fall within the spirit and connotation of the appended claims.

With the rapid development of communication technology, there are more and more types of antennas. However, due to the structural limitations, some antennas may not achieve a wide range of beam coverage while ensuring a certain radiation intensity, which affects the performance of antennas and may not meet the requirements for communication.

For example, in the satellite communication, problems such as the relative motion between the satellite and the earth or the change of the geographical position of the ground communication terminal are usually faced. Therefore, the antenna needs to ensure a certain intensity of circular polarization, and utilize a beam as wide as possible to cover a wider airspace, thus ensuring stable signal connection.

The maximum radiation direction of the common side-emitting circularly polarized antenna is concentrated in the zenith direction. However, due to the compact installation space, it is difficult for the antenna to achieve a wide range of beam coverage. Specifically, the actual gain of the antenna is greater than 0 dBic, with a beam width of only about 120°, and the narrow beam coverage is difficult to meet the requirements for communication. Therefore, it is necessary to provide an antenna structure that may achieve a wide range of beam coverage in a small size while meeting the requirements for radiation intensity.

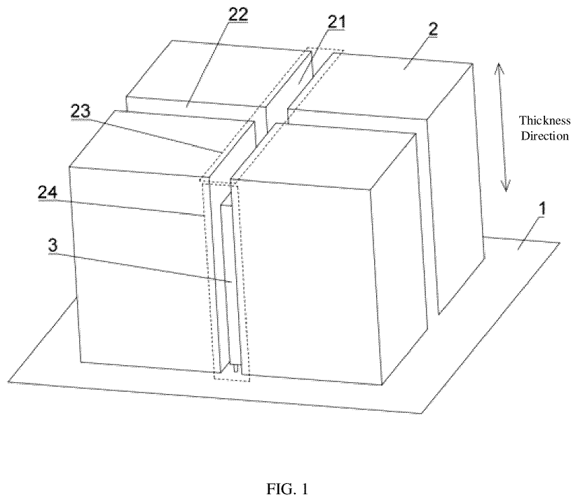

In order to solve the above technical problems, as illustrated in FIG. 1, embodiments of the present disclosure proposes an antenna module, which includes a metal plate 1, a metal body 2 and an excitation source 3. The metal body 2 is provided on the metal plate 1, and the metal body 2 includes a first slot 21 and a second slot 22 arranged crosswise and at a set angle. Each of the first slot 21 and the second slot 22 includes a transverse opening 23 penetrating through the metal body 2 along a thickness direction of the metal plate 1 and a longitudinal opening 24 penetrating through the metal body 2 along a plane direction of the metal plate 1, and a length of the transverse opening 23 and a length of the longitudinal opening 24 are in a set ratio. The excitation source 3 has an excitation end provided in the first slot 21 and the second slot 22, and the excitation source 3 is configured to excite the first slot 21 and the second slot 22 to radiate a circularly polarized wave.

It may be understood that the first slot 21 and the second slot 22 are arranged crosswise and at a set angle and the excitation end of the excitation source 3 are provided in the first slot 21 and the second slot 22, such that the excitation source 3 may effectively excite the first slot 21 and the second slot 22 by means of signals varying along a set period, a rotating electric field is realized by using the cooperation of the first slot 21 and the second slot 22, and the radiation of circularly polarized wave is further realized. At the same time, the metal body 2 is provided on the metal plate 1, such that the metal plate 1 may utilize reflection to radiate the circularly polarized wave generated by the first slot 21 and the second slot 22 along a direction from the metal plate 1 to the metal body 2, and thus the antenna module forms a side-emitting circularly polarized antenna and meets the requirements for communication.

The antenna module realizes the radiation of circularly polarized wave through the first slot 21 and the second slot 22 in the metal body 2, such that the total space occupation is small; the transverse opening 23 penetrates through the metal body 2 along the thickness direction of the metal body 1 and the longitudinal opening 24 penetrates through the metal body 2 along the plane direction of the metal body 1, such that the length of the transverse opening 23 determines the radiation intensity of circularly polarized wave, and the length of the longitudinal opening 24 determines the coverage range of circularly polarized wave. Therefore, by setting the ratio of the length of the transverse opening 23 to the length of the longitudinal opening 24, a wide range of beam coverage may be achieved in a small size while meeting the requirements of radiation intensity, thus achieving high-performance communication.

It should be noted that when the excitation source 3 achieves the excitation utilizing a signal varying along a set period, the first slot 21 and the second slot 22 are provided in the metal body 2, and the excitation end of the excitation source 3 is provided in the first slot 21 and the second slot 22, such that the excitation source 3 may generate more resonance currents at the first slot 21 and the second slot 22 by using the parasitic effect of the metal body 2, the electric field intensity at the first slot 21 and the second slot 22 is the largest, and circularly polarized wave radiates outward from transverse openings 23 and longitudinal openings 24 of the first slot 21 and the second slot 22.

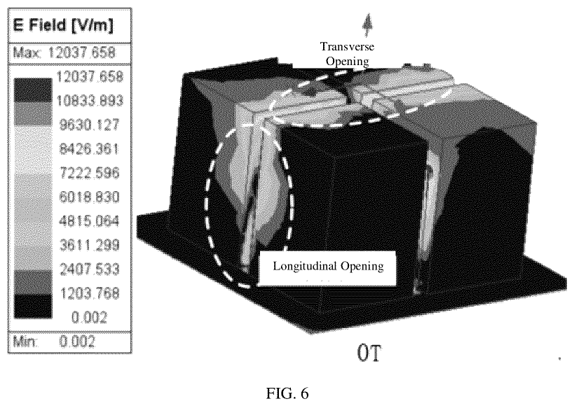

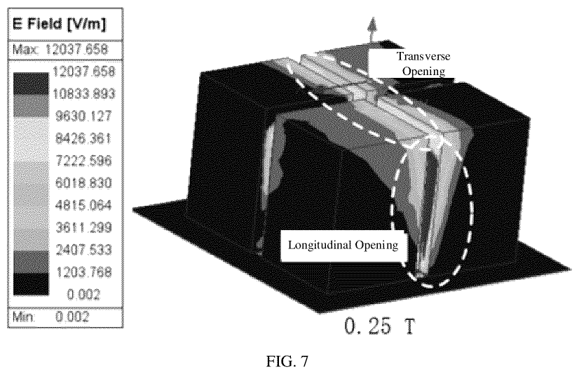

Further, simulation based on the antenna module of the present embodiment is performed, the electric field intensity distribution diagrams as illustrated in FIGS. 6 and 7 are obtained. From FIGS. 6 and 7, it may be seen that the electric field intensity at the transverse opening 23 and the longitudinal opening 24 is the strongest whether the signal period is 0 T or 0.25 T, and the circularly polarized wave is mainly radiated outward from the transverse openings 23 and the longitudinal openings 24 of the first slot 21 and the second slot 22.

The longer the transverse opening 23 is, the more circularly polarized waves will pass, and the shorter the transverse opening 23 is, the less circularly polarized waves will pass. At the same time, since the transverse opening 23 penetrates through the metal body 2 along the thickness direction of the metal plate 1, the length of the transverse opening 23 determines the radiation intensity of the antenna module. The longer the longitudinal opening 24 is, the more circularly polarized waves will pass, and the shorter the longitudinal opening 24 is, the less circularly polarized waves will pass. At the same time, since the longitudinal opening 24 penetrates through the metal body 2 along the plane direction of the metal plate 1, the length of the longitudinal opening 24 determines the radiation range of the antenna module.

Moreover, since the total amount of energy excited by the excitation source 3 is fixed, when the radiation intensity at the transverse opening 23 increases, the radiation intensity at the longitudinal opening 24 will decrease correspondingly, and when the radiation intensity at the transverse opening 23 decreases, the radiation intensity at the longitudinal opening 24 will increase correspondingly, that is, the radiation intensity at the transverse opening 23 and the radiation intensity at the longitudinal opening 24 is inversely proportional. Therefore, different set ratios between the length of the transverse opening 23 and the length of the longitudinal opening 24 enable the antenna module to have different radiation intensity and beam coverage, and the appropriate set ratio may be selected according to actual needs, such that a wide range of beam coverage may be achieved while meeting the requirements of radiation intensity.

The metal plate 1 is used to carry the metal body 2 and reflect the circularly polarized wave radiated by the first slot 21 and the second slot 22, to form a side-emitting antenna as a whole. The specific type of the metal plate 1 may be set according to actual needs, which is not restricted. For example, the metal plate 1 may be a floor structure in a circuit board, which is made of copper, and a size of the metal plate 1 is larger than a size of the metal body 2, and the metal body 2 is located at a middle part of the metal plate 1.

The metal plate 1 has a thickness direction and a plane direction, and the thickness direction and the plane direction are perpendicular to each other. Specifically, the thickness direction of the metal plate 1 may be a Z direction in a coordinate system, and the plane direction of the metal plate 1 may be an XOY plane direction in the coordinate system, and the XOY plane direction refers to any direction in an XOY plane.

The metal body 2 is used to define the first slot 21 and the second slot 22, and plays a parasitic role in cooperation with the excitation source 3. The specific type of the metal body 2 may be set according to actual needs, which is not restricted. For example, the metal body 2 may be a cuboid structure, and the first slot 21 and the second slot 22 are formed from a middle of the metal body 2 to a periphery.

The first slot 21 and the second slot 22 are used for impedance matching of the excitation signal of the excitation source 3, to radiate the circularly polarized wave in cooperation with each other. The set angle between the first slot 21 and the second slot 22 may be set according to actual needs, which is not restricted. For example, the set angle between the first slot 21 and the second slot 22 may be 90 degrees, that is, an arrangement direction of the first slot 21 is perpendicular to an arrangement direction of the second slot 22.

Since each of the first slot 21 and the second slot 22 includes the transverse opening 23 penetrating through the metal body 2 along the thickness direction of the metal plate 1 and the longitudinal opening 24 penetrating through the metal body 2 along the plane direction of the metal plate 1, the first slot 21 and the second slot 22 form a cross-shaped slot penetrating through the metal body 2 along the thickness direction of the metal plate 1, and a length direction of the transverse opening 23 is located in the plane direction of the metal plate 1, and a length direction of the longitudinal opening 24 is located in the thickness direction of the metal plate 1.

The excitation source 3 is used to excite the first slot 21 and the second slot 22 such that the first slot 21 and the second slot 22 radiate the circularly polarized wave. Specifically, the excitation source 3 causes the first slot 21 and the second slot 22 to generate an electric field that varies periodically by control of the signal phase, thereby generating the circularly polarized wave with the varying electric field. The specific type of the excitation source 3 may be set according to actual needs, which is not restricted.

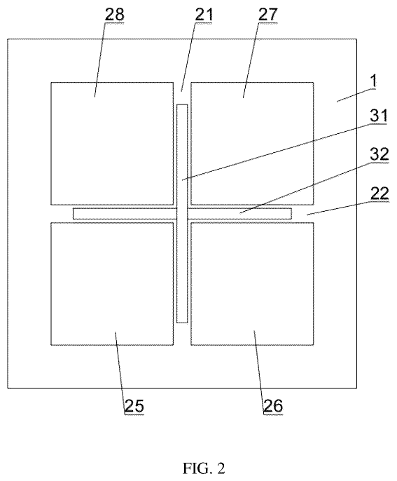

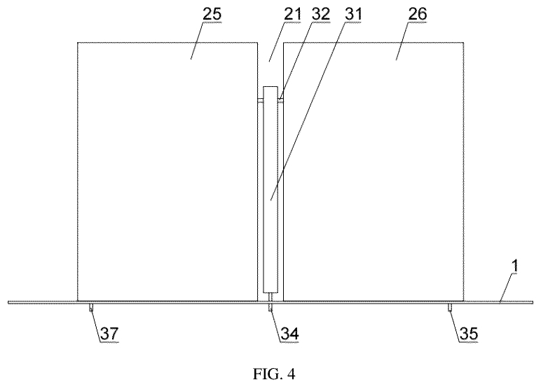

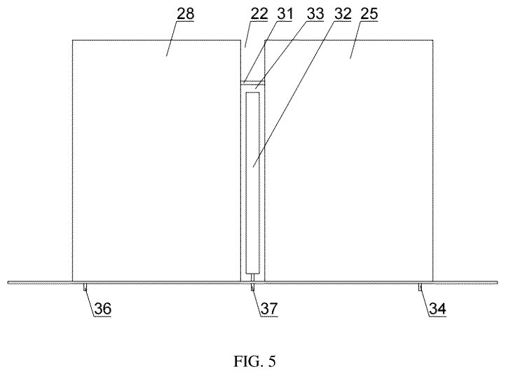

As illustrated in FIG. 2, FIG. 4 and FIG. 5, in some embodiments, the metal body 2 includes a first metal post 25, a second metal post 26, a third metal post 27 and a fourth metal post 28, which are provided on the metal plate 1 and distributed at intervals along a circumferential direction of the metal plate 1. The first slot 21 is defined between the first metal post 25 and the second metal post 26 and between the third metal post 27 and the fourth metal post 28, and the second slot 22 is defined between the first metal post 25 and the fourth metal post 28 and between the second metal post 26 and the third metal post 27.

It may be understood that the excitation end of the excitation source 3 is provided in the first slot 21 and the second slot 22, such that the excitation source 3 may effectively excite the first slot 21 and the second slot 22 by using the parasitism of the first metal post 25, the second metal post 26, the third metal post 27 and the fourth metal post 28 and the signals varying along a set period, thereby realizing the rotating electric field by cooperation of the first slot 21 and the second slot 22, then realizing the radiation of the circularly polarized wave to meet the requirements for communication.

It should be noted that the first metal post 25, the second metal post 26, the third metal post 27 and the fourth metal post 28 are metal structures distributed at intervals in sequence along the circumferential direction of the metal plate 1, which play a parasitic role when the excitation source 3 excites signals, thus ensuring that strong circularly polarized wave may be excited at the first slot 21 and the second slot 22. The specific types of the first metal post 25, the second metal post 26, the third metal post 27 and the fourth metal post 28 may be set according to the actual needs, which is not restricted.

The sizes of the first metal post 25, the second metal post 26, the third metal post 27 and the fourth metal post 28 determine the lengths of the transverse opening 23 and the longitudinal opening 24 in the first slot 21, and the lengths of the transverse opening 23 and the longitudinal opening 24 in the second slot 22. Specifically, since the first slot 21 is defined between the first metal post 25 and the second metal post 26 and between the third metal post 27 and the fourth metal post 28, the larger the sizes of the first metal post 25, the second metal post 26, the third pillar 27 and the fourth metal post 28 along the plane direction of the metal plate 1, the longer the transverse opening 23 in the first slot 21; and the larger the sizes of the first metal post 25, the second metal post 26, the third pillar 27 and the fourth metal post 28 along the thickness direction of the metal plate 1, the longer the longitudinal opening 24 in the first slot 21. Similarly, the larger the sizes of the first metal post 25, the fourth metal post 28, the second metal post 26 and the third metal post 27 along the plane direction of the metal plate 1, the longer the transverse opening 23 in the second slot 22, and the larger the sizes of the first metal post 25, the fourth metal post 28, the second metal post 26 and the third metal post 27 along the thickness direction of the metal plate 1, the longer the longitudinal opening 24 in the second slot 22.

The specific sizes of the first metal post 25, the second metal post 26, the third metal post 27 and the fourth metal post 28 may be set according to actual needs, which are not restricted.

As illustrated in FIGS. 1, 2, 4 and 5, in some embodiments, the first metal post 25 and the second metal post 26 are symmetrically arranged along the first slot 21, the third metal post 27 and the fourth metal post 28 are symmetrically arranged along the first slot 21, the first metal post 25 and the fourth metal post 28 are symmetrically arranged along the second slot 22, and the second metal post 26 and the third metal post 27 are symmetrically arranged along the second slot 22.

It may be understood that since the excitation source 3 excites the first slot 21 and the second slot 22 by means of signals varying along a set period, the first slot 21 and the second slot 22 cooperate alternately to realize the rotating electric field to realize the radiation of the circularly polarized wave. Therefore, when the first metal post 25 and the second metal post 26 are symmetrically arranged along the first slot 21, the third metal post 27 and the fourth metal post 28 are symmetrically arranged along the first slot 21, the first metal post 25 and the fourth metal post 28 are symmetrically arranged along the second slot 22 and the second metal post 26 and the third metal post 27 are symmetrically arranged along the second slot 22, the sizes of the first slot 21 and the second slot 22 may be nearly equal or even completely equal, thus, it is convenient to realize that the signal amplitude radiated by the first slot 21 is equal to the signal amplitude radiated by the second slot 22, such that the pattern of the antenna module has higher roundness and better symmetry, and further meet the requirements for high-performance communication.

It should be noted that the ways to make the first metal post 25 and the second metal post 26 symmetrical along the first slot 21 and the third metal post 27 and the fourth metal post 28 symmetrical along the first slot 21, and the ways to make the first metal post 25 and the fourth metal post 28 symmetrical along the second slot 22 and the second metal post 26 and the third metal post 27 symmetrical along the second slot 22 may be set according to the actual needs, which are not restricted. For example, the first metal post 25, the second metal post 26, the third metal post 27 and the fourth metal post 28 may be provided in a prism structure, a cuboid structure or the like with an identical size.

As illustrated in FIG. 2, in some embodiments, each of the first metal post 25, the second metal post 26, the third metal post 27 and the fourth metal post 28 is a cuboid with a square bottom.

It may be understood that since the excitation source 3 excites the first slot 21 and the second slot 22 by means of signals varying along a set period, the first slot 21 and the second slot 22 cooperate alternately to realize the rotating electric field, so as to realize the radiation of circularly polarized wave. Furthermore, the first slot 21 and the second slot 22 are defined between the first metal post 25, the second metal post 26, the third metal post 27 and the fourth metal post 28, therefore, when each of the first metal post 25, the second metal post 26, the third metal post 27 and the fourth metal post 28 is a cuboid with a square bottom, the sizes of the first slot 21 and the second slot 22 may be nearly equal or even completely equal, such that it is convenient to realize that the signal amplitude radiated by the first slot 21 is equal to the signal amplitude radiated by the second slot 22, such that the pattern of the antenna module has higher roundness and better symmetry, thus meeting the requirements for high-performance communication.

It should be noted that when the first metal post 25 and the second metal post 26 are symmetrically arranged along the first slot 21, the third metal post 27 and the fourth metal post 28 are symmetrically arranged along the first slot 21, the first metal post 25 and the fourth metal post 28 are symmetrically arranged along the second slot 22, and the second metal post 26 and the third metal post 27 are symmetrically arranged along the second slot 22, the first metal post 25, the second metal post 26, the third metal post 27 and the fourth metal post 28 may all be cuboids with square bottoms at the same time, such that the roundness and symmetry of the antenna module pattern may be optimized.

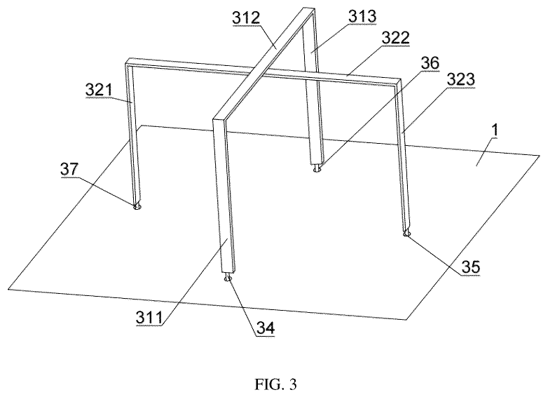

As illustrated in FIG. 2, FIG. 3, FIG. 4 and FIG. 5, in some embodiments, the excitation source 3 includes a first metal ring 31, a second metal ring 32 and a feed source (not illustrated in the figure). The first metal ring 31 is provided in the first slot 21, and the first metal ring 31 and the metal body 2 are in non-contact coupling, while the second metal ring 32 is provided in the second slot 22, and the second metal ring 32 and the metal body 2 are in non-contact coupling. A gap 33 is defined between the second metal ring 32 and the first metal ring 31, and a feeding end of the feed source is connected with at least one end of the first metal ring 31 and at least one end of the second metal ring 32, and the feed source is configured to excite the first slot 21 and the second slot 22 by means of the first metal ring 31 and the second metal ring 32 to radiate the circularly polarized wave.

It may be understood that the first metal ring 31 is provided in the first slot 21, and the first metal ring 31 and the metal body 2 are in non-contact coupling, and the feeding end of the feed source is connected with at least one end of the first metal ring 31, such that the feed source may excite the first metal ring 31 by means of a signal varying along a set period, and realize the excitation of the first slot 21 by means of the parasitic cooperation of the first metal ring 31 and the metal body 2; the second metal ring 32 is provided in the second slot 22, and the second metal ring 32 and the metal body 2 are in non-contact coupling, and the feeding end of the feed source is connected with at least one end of the second metal ring 32, such that the feed source may excite the second metal ring 32 by means of a signal varying along a set period, and realize the excitation of the second slot 22 by means of the parasitic cooperation of the second metal ring 32 and the metal body 2. Therefore, through the cooperation of the first metal ring 31 and the second metal ring 32, the first slot 21 and the second slot 22 may be effectively excited, thereby realizing the efficient radiation of circularly polarized wave.

It should be noted that the first metal ring 31 is used to generate resonant current under the excitation of the feed source, and at the same time parasitic current is generated on the metal body 2. Therefore, the first metal ring 31 cooperates with the metal body 2 to realize the excitation of the first slot 21, and then cooperates with the second slot 22 to generate the circularly polarized wave. The specific type of the first metal ring 31 may be set according to actual needs, which is not restricted. For example, the first metal ring 31 may be a U-shaped structure, and a U-shaped opening of the first metal ring 31 faces the metal plate 1 and forms a closed annular structure with the metal plate 1.

The second metal ring 32 is used to generate a resonant current under the excitation of the feed source, and at the same time parasitic current is generated on the metal body 2. Therefore, the second metal ring 32 cooperates with the metal body 2 to realize the excitation of the second slot 22, and then cooperates with the first slot 21 to generate the circularly polarized wave. The specific type of the second metal ring 32 may be set according to actual needs, which is not restricted. For example, the second metal ring 32 may be a U-shaped structure, and a U-shaped opening of the second metal ring 32 faces the metal plate 1 and forms a closed annular structure with the metal plate 1.

Different sizes of the first metal ring 31 and the second metal ring 32 may form different resonance currents, thereby generating circularly polarized waves in different frequency bands, and the specific sizes of the first metal ring 31 and the second metal ring 32 may be set according to actual needs, which is not restricted.

The first metal ring 31 and the second metal ring 32 are separately in non-contact coupling with the metal body 2. Specifically, the first metal ring 31 and the second metal ring 32 are separately out of contact with the first metal post 25, the second metal post 26, the third metal post 27 and the fourth metal post 28, and distances of the first metal ring 31 and the second metal ring 32 from the first metal post 25, the second metal post 26, the third metal post 27 and the fourth metal post 28 may make the first metal post 25, the second metal post 26, the third metal post 27 and the fourth metal post 28 generate the parasitic current when the first metal ring 31 and the second metal ring 32 generate resonance current.

The feed source is used to feed the excitation signal to the first metal ring 31 and the second metal ring 32, and the specific type of the feed source may be set according to the actual needs, which is not restricted. For example, the feed source may be a feed circuit or chip in a circuit board, etc.

The feeding end of the feed source may be connected to only one end of the first metal ring 31 or be connected to two ends of the first metal ring 31 at the same time. Similarly, the feeding end of the feed source may be connected to only one end of the second metal ring 32 or be connected to two ends of the second metal ring 32 at the same time, which is not restricted. However, it should be noted that the purpose of the feed source is to feed the signal with periodically varying phases to the first metal ring 31 and the second metal ring 32, so as to ensure that the first slot 21 and the second slot 22 may radiate the circularly polarized wave.

As illustrated in FIG. 3, in some embodiments, the first metal ring 31 includes a first metal arm 311, a second metal arm 312 and a third metal arm 313. The first metal arm 311 is provided in the first slot 21 and arranged along the thickness direction of the metal plate 1. The second metal arm 312 is provided in the first slot 21 and arranged along the plane direction of the metal plate 1, and the gap 33 is defined between the second metal arm 312 and the second metal ring 32. The third metal arm 313 is provided in the first slot 21 and arranged along the thickness direction of the metal plate 1. An end of the first metal arm 311 away from the metal plate 1 is connected with an end of the second metal arm 312, an end of the third metal arm 313 away from the metal plate 1 is connected with an end of the second metal arm 312 away from the first metal arm 311, an end of the first metal arm 311 near the metal plate 1 is connected with the feeding end of the feed source, and/or an end of the third metal arm 313 near the metal plate 1 is connected with the feeding end of the feed source.

It may be understood that an end of the first metal arm 311 away from the metal plate 1 is connected with an end of the second metal arm 312, and an end of the third metal arm 313 away from the metal plate 1 is connected with an end of the second metal arm 312 away from the first metal arm 311, such that the first metal arm 311, the second metal arm 312 and the third metal arm 313 form a first metal ring 31 with a U-shaped structure, which enables the first metal ring 31 to not only adapt to the first slot 21 with a small space, but also have a large radiation area. Also, when the feed source feeds signals to the first metal arm 311 and/or the third metal arm 313, resonant currents may be excited on the first metal arm 311, the second metal arm 312 and the third metal arm 313, such that the first slot 21 may be effectively excited by means of the cooperation of the first metal arm 311, the second metal arm 312 and the third metal arm 313 with the metal body 2, and then the high-performance radiation of circularly polarized wave is realized in cooperation with the second slot 22.

It should be noted that the first metal arm 311, the second metal arm 312 and the third metal arm 313 are connected in sequence to form the first metal ring 31 with a U-shaped structure, and the specific types of the first metal arm 311, the second metal arm 312 and the third metal arm 313 may be set according to actual needs, which is not restricted.

As illustrated in FIG. 3, in some embodiments, the second metal ring 32 includes a fourth metal arm 321, a fifth metal arm 322 and a sixth metal arm 323. The fourth metal arm 321 is provided in the second slot 22 and arranged along the thickness direction of the metal plate 1. The fifth metal arm 322 is provided in the second slot 22 and arranged along the plane direction of the metal plate 1, and the gap 33 is defined between the fifth metal arm 322 and the first metal ring 31. The sixth metal arm 323 is provided in the second slot 22 and arranged along the thickness direction of the metal plate 1. An end of the fourth metal arm 321 away from the metal plate 1 is connected with an end of the fifth metal arm 322, an end of the sixth metal arm 323 away from the metal plate 1 is connected with an end of the fifth metal arm 322 away from the fourth metal arm 321, an end of the fourth metal arm 321 near the metal plate 1 is connected with the feeding end of the feed source, and/or an end of the sixth metal arm 323 near the metal plate 1 is connected with the feeding end of the feed source.

It may be understood that an end of the fourth metal arm 321 away from the metal plate 1 is connected with an end of the fifth metal arm 322, and an end of the sixth metal arm 323 away from the metal plate 1 is connected with an end of the fifth metal arm 322 away from the fourth metal arm 321, such that the fourth metal arm 321, the fifth metal arm 322 and the sixth metal arm 323 form a second metal ring 32 with a U-shaped structure, which enable the second metal ring 32 to not only adapt to the second slot 22 with a small space, but also have a large radiation area. Also, when the feed source feeds a signal to the fourth metal arm 321 and/or the sixth metal arm 323, resonant currents may be excited on the fourth metal arm 321, the fifth metal arm 322 and the sixth metal arm 323, such that the second slot 22 may be effectively excited by means of the cooperation of the fourth metal arm 321, the fifth metal arm 322 and the sixth metal arm 323 with the metal body 2, and then the high performance radiation of the circularly polarized wave may be realized by means of the cooperation with the first slot 21.

It should be noted that the fourth metal arm 321, the fifth metal arm 322 and the sixth metal arm 323 are connected in sequence to form the second metal ring 32 with a U-shaped structure, and the specific types of the fourth metal arm 321, the fifth metal arm 322 and the sixth metal arm 323 may be set according to actual needs, which is not restricted.

The gap 33 between the first metal ring 31 and the second metal ring 32 may reduce the mutual influence between the first metal ring 31 and the second metal ring 32, ensure the stable formation of circularly polarized wave, and meanwhile, make the pattern of the antenna module have higher roundness and better symmetry. Specifically, the gap 33 is set between the second metal arm 312 and the fifth metal arm 322, and the fifth metal arm 322 is located between the second metal arm 312 and the metal plate 1.

In some embodiments, a first feeding end of the feed source is connected with an end of the first metal ring 31, and the first feeding end of the feed source is configured to feed a first signal to the first metal ring 31; a second feeding end of the feed source is connected with an end of the second metal ring 32, and the second feeding end of the feed source is configured to feed a second signal to the second metal ring 32; a third feeding end of the feed source is connected with an end of the first metal ring 31 away from the first feeding end of the feed source, and the third feeding end of the feed source is configured to feed a third signal to the first metal ring; and a fourth feeding end of the feed source is connected with an end of the second metal ring 32 away from the second feeding end of the feed source, and the fourth feeding end of the feed source is configured to feed a fourth signal to the second metal ring. The first feeding end, the second feeding end, the third feeding end and the fourth feeding end of the feed source are distributed at intervals along the circumferential direction of the metal plate 1, and the first signal, the second signal, the third signal and the fourth signal are of equal amplitude and have a phase difference of 90 degrees in sequence.

It may be understood that the feed source uses the first feeding end, the second feeding end, the third feeding end and the fourth feeding end to feed the first metal ring 31 and the second metal ring 32 with the first signal, the second signal, the third signal and the fourth signal, which have equal amplitude and a phase difference of 90 degrees in sequence, to effectively excite the first slot 21 and the second slot 22 by means of the first signal, the second signal, the third signal and the fourth signal, and further realize the rotating electric field by means of the cooperation of the first slot 21 and the second slot 22, such that the radiation of circularly polarized wave is realized and the requirements for high-performance communication are met.

It should be noted that the feed source has a first feeding end, a second feeding end, a third feeding end and a fourth feeding end, and the first feeding end, the second feeding end, the third feeding end and the fourth feeding end feed the first signal, the second signal, the third signal and the fourth signal, respectively.

As illustrated in FIG. 3, FIG. 4 and FIG. 5, in some embodiments, the excitation source 3 further includes a first feeding pin 34, a second feeding pin 35, a third feeding pin 36 and a fourth feeding pin 37. The first feeding pin 34 is provided at the first feeding end of the feed source, and the first feeding pin 34 is connected with an end of the first metal ring 31 away from the third feeding end of the feed source, and the first feeding pin 34 penetrates through the metal plate 1 and is not in contact with the metal plate 1. The second feeding pin 35 is provided at the second feeding end of the feed source and is connected with an end of the second metal ring 32 away from the fourth feeding end of the feed source, and the second feeding pin 35 penetrates through the metal plate 1 and is not in contact with the metal plate 1. The third feeding pin 36 is provided at the third feeding end of the feed source and is connected with an end of the first metal ring 31 away from the first feeding end, and the third feeding pin 36 penetrates through the metal plate 1 and is not in contact with the metal plate 1. The fourth feeding pin 37 is provided at the fourth feeding end of the feed source, and the fourth feeding pin 37 is connected with an end of the second metal ring 32 away from the second feeding end of the feed source, and the fourth feeding pin 37 penetrates through the metal plate 1 and is not in contact with the metal plate 1.

It may be understood that the first feeding pin 34 is provided at the first feeding end of the feed source, and the first feeding pin 34 is connected with an end of the first metal ring 31 away from the third feeding end of the feed source, such that the first feeding end of the feed source may feed the first signal to the first metal ring 31 by means of the first feeding pin 34. The second feeding pin 35 is provided at the second feeding end of the feed source, and the second feeding pin 35 is connected with an end of the second metal ring 32 away from the fourth feeding end of the feed source, such that the second feeding end of the feed source may feed the second signal to the second metal ring 32 by means of the second feeding pin 35. The third feeding pin 36 is provided at the third feeding end of the feed source, and the third feeding pin 36 is connected with an end of the first metal ring 31 away from the first feeding end of the feed source, such that the third feeding end of the feed source may feed the third signal to the first metal ring 31 by means of the third feeding pin 36. The fourth feeding pin 37 is provided at the fourth feeding end of the feed source, and the fourth feeding pin 37 is connected with an end of the second metal ring 32 away from the second feeding end of the feed source, such that the fourth feeding end of the feed source may feed the fourth signal to the second metal ring 32 by means of the fourth feeding pin 37. Therefore, through the arrangement of the first feeding pin 34, the second feeding pin 35, the third feeding pin 36 and the fourth feeding pin 37, it is ensured that the feed source may stably feed the first signal, the second signal, the third signal and the fourth signal to the first metal ring 31 and the second metal ring 32, thereby realizing efficient radiation of circularly polarized wave.

It should be noted that the first feeding pin 34, the second feeding pin 35, the third feeding pin 36 and the fourth feeding pin 37 are used to feed the first signal, the second signal, the third signal and the fourth signal, respectively, and the specific types of the first feeding pin 34, the second feeding pin 35, the third feeding pin 36 and the fourth feeding pin 37 may be set according to actual needs, which is not restricted. For example, the first feeding pin 34, the second feeding pin 35, the third feeding pin 36 and the fourth feeding pin 37 may all be coaxial probes, and corresponding positions of the metal plate 1 are respectively provided with through holes for the first feeding pin 34, the second feeding pin 35, the third feeding pin 36 and the fourth feeding pin 37 to pass through. Taking the first feeding pin 34 as an example, the first feeding pin 34 includes an outer conductor, an inner conductor and a dielectric layer, the outer conductor is fitted over an outside of the inner conductor, and the dielectric layer is provided between the outer conductor and the inner conductor. The first feeding pin 34 penetrates through the through hole, and the outer conductor of the first feeding pin 34 is connected with the metal plate 1, and the inner conductor of the first feeding pin 34 is only connected with the first metal ring 31.

In some embodiments, a ratio of a length of the metal body 2 along the thickness direction of the metal plate 1 to a wavelength of the circularly polarized wave ranges from 0.18:1 to 0.23:1.

It may be understood that since the ratio of the length of the metal body 2 along the thickness direction of the metal plate 1 to the wavelength of the circularly polarized wave ranges from 0.18:1 to 0.23:1, the metal body 2 may radiate circularly polarized wave with high performance by means of the first slot 21 and the second slot 22, and have small space occupation.

It should be noted that the length of the metal body 2 along the thickness direction of the metal plate 1 refers to a height of the metal body 2 in the Z direction, and the ratio of the length of the metal body 2 along the thickness direction of the metal plate 1 to the wavelength of the circularly polarized wave may be 0.18:1, or 0.23:1, or 0.2:1, etc., which is not restricted.

In some embodiments, a ratio of a length of the metal plate 1 to the wavelength of the circularly polarized wave is less than 0.5; and/or a ratio of a width of the metal plate 1 to the wavelength of the circularly polarized wave is less than 0.5.

It may be understood that the ratio of the length of the metal plate 1 to the wavelength of the circularly polarized wave and the ratio of the width of the metal plate 1 to the wavelength of the circularly polarized wave are less than 0.5, such that the metal plate 1 may effectively play a reflection role and have a small size, thereby reducing the space occupation of the antenna module.

It should be noted that the length and width of the metal plate 1 may be equal or similar. The length and width of the metal plate 1 being equal may make the pattern of the antenna module have higher roundness and better symmetry. The ratio of the length of the metal plate 1 to the wavelength of the circularly polarized wave and the ratio of the width of the metal plate 1 to the wavelength of the circularly polarized wave may be 0.49, 0.48, 0.45, 0.43, 0.42, etc., which is not restricted.

In some embodiments, a frequency band of the circularly polarized wave is a satellite mobile communication transmitting frequency band and/or a satellite mobile communication.

It may be understood that the frequency band of circularly polarized wave is a satellite mobile communication transmitting frequency band and/or a satellite mobile communication receiving frequency band, the antenna module may communicate through the satellite mobile communication transmitting frequency band and/or the satellite mobile communication receiving frequency band, thus meeting the requirements of satellite communication.

For example, the transmission frequency range of the satellite mobile communication is 1.98 GHz-2.01 GHz, and the receiving frequency range of the satellite mobile communication is 2.17 GHz-2.2 GHz.

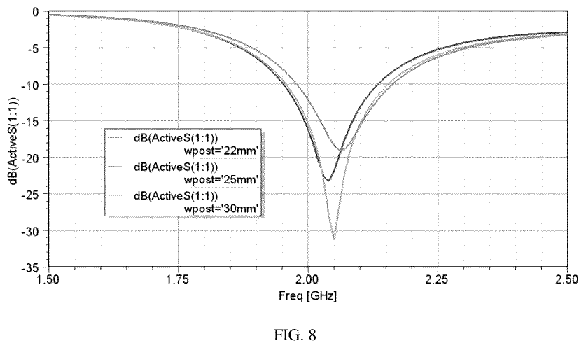

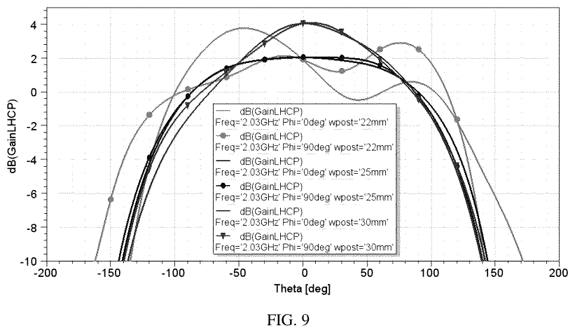

Further, simulation is carried out based on the antenna module of the present embodiment, and the patterns illustrated in FIGS. 8 and 9 are obtained.

In FIG. 8, three curves respectively show the first metal post 25, the second metal post 26, the third metal post 27 and the fourth metal post 28 with different widths (wpost), that is, the widths of the first metal post 25, the second metal post 26, the third metal post 27 and the fourth metal post 28 are equal to 22 mm, 25 mm and 30 mm. As may be seen from the figure, the widths of the first metal post 25, the second metal post 26, the third metal post 27 and the fourth metal post 28 have no influence on the resonant frequency of the antenna module, and the resonant frequency of the antenna module is near 2.01 GHz under different widths. It should be noted that the widths and lengths of the first metal post 25, the second metal post 26, the third metal post 27 and the fourth metal post 28 are equal. The width direction and the length direction of the first metal post 25, the second metal post 26, the third metal post 27 and the fourth metal post 28 are all located in the plane direction of the metal plate 1, and only the sizes of the first metal ring 31 and the second metal ring 32 in the antenna module determine the overall resonance frequency (frequency band of circularly polarized wave).

In FIG. 9, six curves are divided into three groups, and each group has two curves. The difference between the two curves in each group is that one curve indicates that Phi is equal to 0 deg, while the other curve indicates that Phi is equal to 90 deg. Meanwhile, all three groups of curves are generated when the frequency band of circularly polarized wave is at 2.03 GHz. Moreover, three groups of curves represent that the widths of the first metal post 25, the second metal post 26, the third metal post 27 and the fourth metal post 28 are equal to 22 mm, 25 mm and 30 mm respectively. As may be seen from FIG. 9, when the widths of the first metal post 25, the second metal post 26, the third metal post 27 and the fourth metal post 28 are larger, the electric field effect of the transverse opening 23 is more obvious, and the radiation intensity in the Z direction (zenith direction) is the largest while the beam is narrow. When the widths of the first metal post 25, the second metal post 26, the third metal post 27 and the fourth metal post 28 are smaller, the electric field effect of the longitudinal opening 24 is more obvious, and the radiation intensity in the Z direction (zenith direction) is weakened and a depression appears, while the beam is obviously widened. It should be noted that the widths of the first metal post 25, the second metal post 26, the third metal post 27 and the fourth metal post 28 should not be too small, such as the curve of 22 mm, which has obvious fluctuation of gain in the range of angle from −100 to +100, poor symmetry and poor consistency of gain under different Phi values. On the contrary, when the widths of the first metal post 25, the second metal post 26, the third metal post 27 and the fourth metal post 28 are appropriate sizes such as 25 mm and 30 mm, the symmetry of the curve is good, and the consistency of the gain is high under different Phi values, such that the antenna module has high communication performance.

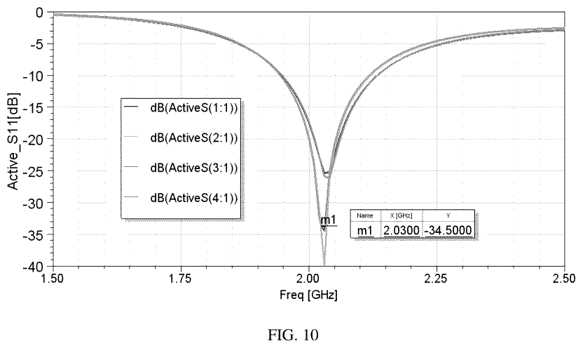

Simulation is performed based on the antenna module of the present embodiment, and a port reflection coefficient graph as illustrated in FIG. 10 is obtained. As illustrated in FIG. 10, the port reflection coefficients of S (1:1) curve, S (2:1) curve, S (3:1) curve and S (4:1) curve near 2.01 GHz are all below −10 dB, and the antenna module has high radiation performance.

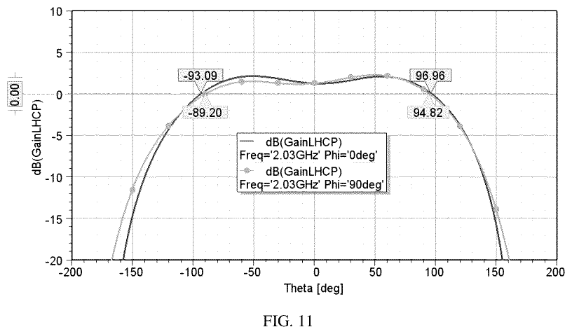

Meanwhile, in FIG. 10, it may be clearly seen from the S (1:1) curve that the antenna module has a well-matched resonance mode. In this mode, the pattern of Phi equal to 0 deg section and the pattern of Phi equal to 90 deg section are illustrated in FIG. 11. As may be seen from FIG. 11, the beam width of the antenna module greater than 0 dBic obviously exceeds 180°. Compared with the prior art, the antenna module of the present embodiment has a wider range of beam coverage.

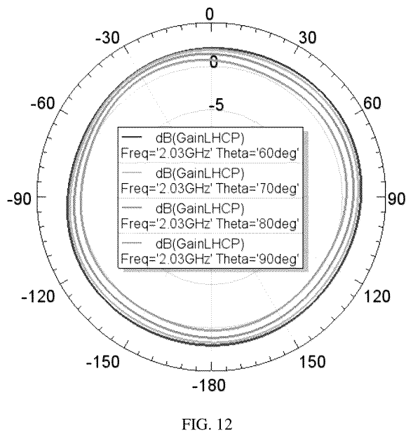

Similarly, the circular polarization gains of the antenna module at sections of theta equal to 60°, 70°, 80° and 90° are illustrated in FIG. 12, from which it may be seen that the pattern of the antenna module has good roundness.

Embodiments of the present disclosure also provide a vehicle, which includes the antenna module described above.

It may be understood that the first slot 21 and the second slot 22 are arranged crosswise and at a set angle, and the excitation end of the excitation source 3 is provided in the first slot 21 and the second slot 22, such that the excitation source 3 may effectively excite the first slot 21 and the second slot 22 by mean of a signal varying along a set period, such that the rotating electric field is realized by mean of the cooperation of the first slot 21 and the second slot 22, and the radiation of circularly polarized wave is further realized. At the same time, the metal body 2 is provided on the metal plate 1, such that the metal plate 1 may utilize reflection to radiate the circularly polarized wave generated by the first slot 21 and the second slot 22 along the direction from the metal plate 1 to the metal body 2, and thus the antenna module forms a side-emitting circularly polarized antenna and meets the requirements for communication.

The antenna module realizes radiation of circularly polarized wave through the first slot 21 and the second slot 22 on the metal body 2, such that the total space occupation is small; the transverse opening 23 penetrates through the metal body 2 along the thickness direction of the metal body 1 and the longitudinal opening 24 penetrates through the metal body 2 along the plane direction of the metal body 1, such that the length of the transverse opening 23 determines the radiation intensity of circularly polarized wave, and the length of the longitudinal opening 24 determines the coverage range of circularly polarized wave. Therefore, by setting the ratio of the length of the transverse opening 23 to the length of the longitudinal opening 24, a wide range of beam coverage may be achieved in a smaller size while meeting the requirements of radiation intensity, thus achieving high-performance communication.

It should be noted that the specific types of vehicles may be set according to actual needs, which is not restricted. For example, the vehicle may be an electric vehicle, a fuel vehicle, a hybrid vehicle and so on.

Embodiments of the present disclosure also provide a base station, which includes the antenna module described above.

The first slot 21 and the second slot 22 are arranged crosswise and at a set angle, and the excitation end of the excitation source 3 is provided in the first slot 21 and the second slot 22, the excitation source 3 may effectively excite the first slot 21 and the second slot 22 by means of a signal varying along a set period, such that the rotating electric field is realized by means of the cooperation of the first slot 21 and the second slot 22, and then the radiation of circularly polarized wave is further realized. At the same time, the metal body 2 is provided on the metal plate 1, such that the metal plate 1 may utilize the reflection to radiate circularly polarized wave generated by the first slot 21 and the second slot 22 along the direction from the metal plate 1 to the metal body 2, and thus the antenna module forms a side-emitting circularly polarized antenna and meets the requirements for communication.

The antenna module realizes the radiation of circularly polarized wave through the first slot 21 and the second slot 22 in the metal body 2, the total space occupation is small; the transverse opening 23 penetrates through the metal body 2 along the thickness direction of the metal body 1 and the longitudinal opening 24 penetrates through the metal body 2 along the plane direction of the metal body 1, such that the length of the transverse opening 23 determines the radiation intensity of circularly polarized wave, and the length of the longitudinal opening 24 determines the coverage range of circularly polarized wave. Therefore, by setting the ratio of the length of the transverse opening 23 to the length of the longitudinal opening 24, a wide range of beam coverage may be achieved in a smaller size while meeting the requirements of radiation intensity, thus achieving high-performance communication.

It should be noted that the specific type of the base station may be set according to actual needs, which is not restricted. For example, the base station may be a fixed platform for satellite communication.

A first aspect of the present disclosure provides an antenna module, including a metal plate, a metal body, and an excitation source. The metal body is provided on the metal plate, and includes a first slot and a second slot arranged crosswise and at a set angle. Each of the first slot and the second slot include a transverse opening penetrating through the metal body along a thickness direction of the metal plate and a longitudinal opening penetrating through the metal body along a plane direction of the metal plate. A length of the transverse opening and a length of the longitudinal opening are in a set ratio. The excitation source has an excitation end provided in the first slot and the second slot, and the excitation source is configured to excite the first slot and the second slot to radiate a circularly polarized wave.

In some examples, the metal body includes: a first metal post, a second metal post, a third metal post and a fourth metal post. The first metal post, the second metal post, the third metal post and the fourth metal post are provided on the metal plate and sequentially distributed at intervals along a circumferential direction of the metal plate. The first slot is defined between the first metal post and the second metal post and between the third metal post and the fourth metal post, and the second slot is defined between the first metal post and the fourth metal post and between the second metal post and the third metal post.

In some examples, the first metal post and the second metal post are symmetrically arranged along the first slot, the third metal post and the fourth metal post are symmetrically arranged along the first slot, the first metal post and the fourth metal post are symmetrically arranged along the second slot, and the second metal post and the third metal post are symmetrically arranged along the second slot.

In some examples, each of the first metal post, the second metal post, the third metal post and the fourth metal post is a cuboid with a square bottom.

In some examples, the excitation source includes: a first metal ring provided in the first slot, the first metal ring and the metal body being in non-contact coupling; a second metal ring provided in the second slot, the second metal ring and the metal body being in non-contact coupling, a gap being defined between the second metal ring and the first metal ring; and a feed source having a feeding end connected with at least one end of the first metal ring and at least one end of the second metal ring, and configured to excite the first slot and the second slot by using the first metal ring and the second metal ring, to radiate the circularly polarized wave.

In some examples, the first metal ring includes: a first metal arm provided in the first slot and arranged along the thickness direction of the metal plate; a second metal arm provided in the first slot and arranged along the plane direction of the metal plate, the gap being defined between the second metal arm and the second metal ring; and a third metal arm provided in the first slot and arranged along the thickness direction of the metal plate. An end of the first metal arm away from the metal plate is connected with an end of the second metal arm, and an end of the third metal arm away from the metal plate is connected with an end of the second metal arm away from the first metal arm; an end of the first metal arm close to the metal plate is connected with the feeding end of the feed source, and/or an end of the third metal arm close to the metal plate is connected with the feeding end of the feed source.

In some examples, the second metal ring includes: a fourth metal arm provided in the second slot and arranged along the thickness direction of the metal plate; a fifth metal arm provided in the second slot and arranged along the plane direction of the metal plate, the gap being defined between the fifth metal arm and the first metal ring; and a sixth metal arm provided in the second slot and arranged along the thickness direction of the metal plate. An end of the fourth metal arm away from the metal plate is connected with an end of the fifth metal arm, and an end of the sixth metal arm away from the metal plate is connected with an end of the fifth metal arm away from the fourth metal arm; an end of the fourth metal arm close to the metal plate is connected with the feeding end of the feed source, and/or an end of the sixth metal arm close to the metal plate is connected with the feeding end of the feed source.

In some examples, a first feeding end of the feed source is connected with an end of the first metal ring, and the first feeding end of the feed source is configured to feed a first signal into the first metal ring; a second feeding end of the feed source is connected with an end of the second metal ring, and the second feeding end of the feed source is configured to feed a second signal into the second metal ring; a third feeding end of the feed source is connected with an end of the first metal ring away from the first feeding end of the feed source, and the third feeding end of the feed source is configured to feed a third signal into the first metal ring; a fourth feeding end of the feed source is connected with an end of the second metal ring away from the second feeding end of the feed source, and the fourth feeding end of the feed source is configured to feed a fourth signal into the second metal ring. The first feeding end, the second feeding end, the third feeding end and the fourth feeding end of the feed source are distributed at intervals along the circumferential direction of the metal plate, and the first signal, the second signal, the third signal and the fourth signal are of equal amplitude and have a phase difference of 90 degrees apart in sequence.

In some examples, the excitation source further includes: a first feeding pin provided at the first feeding end of the feed source, connected with an end of the first metal ring away from the third feeding end of the feed source, and penetrating through the metal plate without contacting the metal plate; a second feeding pin provided at the second feeding end of the feed source, connected with an end of the second metal ring away from the fourth feeding end of the feed source, and penetrating through the metal plate without contacting with the metal plate; a third feeding pin provided at the third feeding end of the feed source, connected with an end of the first metal ring away from the first feeding end of the feed source, and penetrating through the metal plate without contacting the metal plate; and a fourth feeding pin provided at the fourth feeding end of the feed source, connected with an end of the second metal ring away from the second feeding end of the feed source, and penetrating through the metal plate without contacting the metal plate.

In some examples, a ratio of a length of the metal body along the thickness direction of the metal plate to a wavelength of the circularly polarized wave ranges from 0.18:1 to 0.23:1.

In some examples, a ratio of a length of the metal plate to a wavelength of the circularly polarized wave is less than 0.5; and/or a ratio of a width of the metal plate to the wavelength of the circularly polarized wave is less than 0.5.

In some examples, a frequency band of the circularly polarized wave is a satellite mobile communication transmitting frequency band and/or a satellite mobile communication antenna receiving frequency band.

A vehicle according to a second aspect of the present disclosure includes an antenna module according to the first aspect of the present disclosure.

A base station according to a third aspect of the present disclosure includes an antenna module according to the first aspect of the present disclosure.

In the description of this disclosure, the terms “first”, “second” and so on are only used for descriptive purposes and may not be understood as indicating or implying relative importance. In addition, in the description of the present disclosure, unless otherwise specified, “a plurality of” means two or more.

Any description of process or method in the flowchart or otherwise described herein may be understood as representing a module, a segment or part of code that includes one or more executable instructions for implementing specific logical functions or steps of the process, and the scope of preferred embodiments of the present disclosure includes other implementations, in which functions may be performed out of the order illustrated or discussed, including performing functions in a substantially simultaneous manner or in the reverse order according to the functions involved, which should be understood by those skilled in the field to which embodiments of the present disclosure belong.

In the description of this specification, descriptions referring to the terms “an embodiment”, “some embodiments”, “an example”, “a specific example” or “some examples” mean that specific features, structures, materials or characteristics described in connection with this embodiment or example are included in at least one embodiment or example of this disclosure. In this specification, the schematic expressions of the above terms do not necessarily refer to the same embodiment or example. Moreover, the specific features, structures, materials or characteristics described may be combined in any one or more embodiments or examples in a suitable manner.

Although embodiments of the present disclosure have been illustrated and described above, it may be understood that the above embodiments are illustrative and may not be understood as limitations to the present disclosure, and those skilled in the art may make changes, modifications, substitutions and variations to the above embodiments within the scope of the present disclosure.

What is claimed is:

1. An antenna module, comprising:
a metal plate;
a metal body provided on the metal plate and comprising a first slot and a second slot arranged crosswise and at a set angle, each of the first slot and the second slot comprising a transverse opening penetrating through the metal body along a thickness direction of the metal plate and a longitudinal opening penetrating through the metal body along a plane direction of the metal plate, a length of the transverse opening and a length of the longitudinal opening being in a set ratio; and
an excitation source having an excitation end provided in the first slot and the second slot, and configured to excite the first slot and the second slot to radiate a circularly polarized wave.

2. The antenna module according to claim 1, wherein the metal body comprises a first metal post, a second metal post, a third metal post and a fourth metal post, the first metal post, the second metal post, the third metal post and the fourth metal post are provided on the metal plate and sequentially distributed at intervals along a circumferential direction of the metal plate; and
wherein the first slot is defined between the first metal post and the second metal post and between the third metal post and the fourth metal post, and the second slot is defined between the first metal post and the fourth metal post and between the second metal post and the third metal post.

3. The antenna module according to claim 2, wherein the first metal post and the second metal post are symmetrically arranged along the first slot, the third metal post and the fourth metal post are symmetrically arranged along the first slot, the first metal post and the fourth metal post are symmetrically arranged along the second slot, and the second metal post and the third metal post are symmetrically arranged along the second slot.

4. The antenna module according to claim 2, wherein the first metal post, the second metal post, the third metal post and the fourth metal post are provided in a prism structure or a cuboid structure with an identical size.

5. The antenna module according to claim 2, wherein each of the first metal post, the second metal post, the third metal post and the fourth metal post is a cuboid with a square bottom.

6. The antenna module according to claim 1, wherein the excitation source comprises:
a first metal ring provided in the first slot, the first metal ring and the metal body being in non-contact coupling;
a second metal ring provided in the second slot, the second metal ring and the metal body being in non-contact coupling, a gap being defined between the second metal ring and the first metal ring; and
a feed source having a feeding end feed connected with at least an end of the first metal ring and at least an end of the second metal ring, and configured to excite the first slot and the second slot by using the first metal ring and the second metal ring, to radiate the circularly polarized wave.

7. The antenna module according to claim 6, wherein the first metal ring comprises:
a first metal arm provided in the first slot and arranged along the thickness direction of the metal plate;
a second metal arm provided in the first slot and arranged along the plane direction of the metal plate, the gap being defined between the second metal arm and the second metal ring; and
a third metal arm provided in the first slot and arranged along the thickness direction of the metal plate;
wherein an end of the first metal arm away from the metal plate is connected with an end of the second metal arm, and an end of the third metal arm away from the metal plate is connected with an end of the second metal arm away from the first metal arm;
at least one of an end of the first metal arm close to the metal plate or an end of the third metal arm close to the metal plate is connected with the feeding end of the feed source.

8. The antenna module according to claim 6, wherein the second metal ring comprises:
a fourth metal arm provided in the second slot and arranged along the thickness direction of the metal plate;
a fifth metal arm provided in the second slot and arranged along the plane direction of the metal plate, the gap being defined between the fifth metal arm and the first metal ring; and
a sixth metal arm provided in the second slot and arranged along the thickness direction of the metal plate;
wherein an end of the fourth metal arm away from the metal plate is connected with an end of the fifth metal arm, and an end of the sixth metal arm away from the metal plate is connected with an end of the fifth metal arm away from the fourth metal arm;
at least one of an end of the fourth metal arm close to the metal plate or an end of the sixth metal arm close to the metal plate is connected with the feeding end of the feed source.

9. The antenna module according to claim 6, wherein,
a first feeding end of the feed source is connected with an end of the first metal ring, and the first feeding end of the feed source is configured to feed a first signal into the first metal ring;
a second feeding end of the feed source is connected with an end of the second metal ring, and the second feeding end of the feed source is configured to feed a second signal into the second metal ring;
a third feeding end of the feed source is connected with an end of the first metal ring away from the first feeding end of the feed source, and the third feeding end of the feed source is configured to feed a third signal into the first metal ring;
a fourth feeding end of the feed source is connected with an end of the second metal ring away from the second feeding end of the feed source, and the fourth feeding end of the feed source is configured to feed a fourth signal into the second metal ring;
wherein, the first feeding end, the second feeding end, the third feeding end and the fourth feeding end of the feed source are distributed at intervals along the circumferential direction of the metal plate, and the first signal, the second signal, the third signal and the fourth signal are of equal amplitude and have a phase difference of 90 degrees in sequence.

10. The antenna module according to claim 9, wherein the excitation source further comprises:
a first feeding pin provided at the first feeding end of the feed source, connected with an end of the first metal ring away from the third feeding end of the feed source, and penetrating through the metal plate without contacting the metal plate;
a second feeding pin provided at the second feeding end of the feed source, connected with an end of the second metal ring away from the fourth feeding end of the feed source, and penetrating through the metal plate without contacting with the metal plate;
a third feeding pin provided at the third feeding end of the feed source, connected with an end of the first metal ring away from the first feeding end of the feed source, and penetrating through the metal plate without contacting the metal plate; and
a fourth feeding pin provided at the fourth feeding end of the feed source, connected with an end of the second metal ring away from the second feeding end of the feed source, and penetrating through the metal plate without contacting the metal plate.

11. The antenna module according to claim 1, wherein a ratio of a length of the metal body along the thickness direction of the metal plate to a wavelength of the circularly polarized wave ranges from 0.18:1 to 0.23:1.

12. The antenna module according to claim 1, wherein a ratio of a length of the metal plate to a wavelength of the circularly polarized wave is less than 0.5.

13. The antenna module according to claim 1, wherein a ratio of a width of the metal plate to a wavelength of the circularly polarized wave is less than 0.5.

14. The antenna module according to claim 1, wherein a ratio of a length of the metal plate to a wavelength of the circularly polarized wave is less than 0.5, and a ratio of a width of the metal plate to the wavelength of the circularly polarized wave is less than 0.5.

15. The antenna module according to claim 1, wherein a frequency band of the circularly polarized wave is at least one of a satellite mobile communication transmitting frequency band or a satellite mobile communication receiving frequency band.

16. The antenna module according to claim 1, wherein the metal plate is a floor structure in a circuit board.

17. The antenna module according to claim 1, wherein a size of the metal plate is larger than a size of the metal body, and the metal body is located at a middle part of the metal plate.

18. The antenna module according to claim 1, wherein the set angle between the first slot and the second slot is 90 degrees.

19. A vehicle, comprising:
an antenna module comprising:
a metal plate;
a metal body provided on the metal plate and comprising a first slot and a second slot arranged crosswise and at a set angle, each of the first slot and the second slot comprising a transverse opening penetrating through the metal body along a thickness direction of the metal plate and a longitudinal opening penetrating through the metal body along a plane direction of the metal plate, a length of the transverse opening and a length of the longitudinal opening being in a set ratio; and
an excitation source having an excitation end provided in the first slot and the second slot, and configured to excite the first slot and the second slot to radiate a circularly polarized wave.

20. A base station, comprising:
an antenna module comprising:
a metal plate;
a metal body provided on the metal plate and comprising a first slot and a second slot arranged crosswise and at a set angle, each of the first slot and the second slot comprising a transverse opening penetrating through the metal body along a thickness direction of the metal plate and a longitudinal opening penetrating through the metal body along a plane direction of the metal plate, a length of the transverse opening and a length of the longitudinal opening being in a set ratio; and
an excitation source having an excitation end provided in the first slot and the second slot, and configured to excite the first slot and the second slot to radiate a circularly polarized wave.
